(19) United States
(12) Patent Application Publication
(10) Pub. No.: US 2006/0291490 A1
(43) Pub. Date: Dec. 28, 2006

(54) Computer-readable recording medium having recorded worm determination program, worm determination method, and worm determination apparatus

(75) Inventors: Kazumasa Omote, Kawasaki (JP); Yoshiki Higashikado, Kawasaki (JP); Masahiro Komura, Kawasaki (JP); Bintatsu Noda, Kawasaki (JP); Masashi Mitomo, Kawasaki (JP); Satoru Torii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/346,243

(22) Filed: Feb. 3, 2006

(30) Foreign Application Priority Data
Jun. 28, 2005 (JP) 2005-187771

(51) Int. Cl. H04L 12/56

(52) U.S. Cl. 370/401

(57) ABSTRACT

A computer-readable recording medium having recorded a worm determination program capable of reliably determining a worm-infected communication. A worm determination apparatus for executing the program includes a plurality of physical ports functioning as network connection ports, a communication-information-acquisition unit, and a worm determination unit. The communication-information-acquisition unit acquires information about a packet type, classified according to a transmission-source address. The worm determination unit determines whether a communication is performed by a worm, based on the information about the packet type, classified according to the transmission-source address, acquired by the communication-information-acquisition unit and a determination criterion used for determining whether a communication is performed by a worm.

### CROSS-REFERENCE TO RELATED APPLICATIONS

This application is based upon and claims the benefits of priority from the prior Japanese Patent Application No. 2005-187771, filed on Jun. 28, 2005, the entire contents of which are incorporated herein by reference.

### BACKGROUND OF THE INVENTION

1. Field of the Invention

The present invention relates to computer-readable recording media having recorded worm determination programs, worm determination methods, and worm determination apparatuses, and in particular to a computer-readable recording medium having recorded a worm determination program, a worm determination method, and a worm determination apparatus for monitoring a communication associated with a predetermined network segment connected to a network to determine whether the communication is a communication carried out by a worm.

2. Description of the Related Art

Methods for detecting worms, which are illicit programs intended for self-multiplication without depending on other programs, are well known.

One example of these detection methods includes a worm detection method for detecting a worm based on a change in the number of destination address types to detect for infectious activities specific to a particular type of sequentially self-propagating worms (refer to, for example, Japanese Unexamined Patent Application Publication No. 2005-056243). In such a worm detection method, the number of sequential destination address types is counted, classified according to transmission-source Internet Protocol (IP) addresses and transmission-source Media Access Control (MAC) addresses, to determine that there is infection with a worm when the number of types is equal to or larger than a threshold.

This worm detection method, however, has an drawback in that it can detect only a certain type of worms which sequentially perform self-propagation. More specifically, this worm detection method determines a worm when the number of destination address types is sequential and is equal to or larger than a predetermined value, and it cannot detect worms other than those that sequentially perform searching.

Furthermore, in the process of detecting and blocking a worm, normal work communications that use the same service port as that used by the worm are also blocked even in non-infected terminals. Ideally, it is desirable that only worm-infected communications be blocked while normal communications are allowed. For this purpose, it is necessary that isolation for blocking only worm-infected communications be made flexible.

### SUMMARY OF THE INVENTION

In view of the foregoing, it is an object of the present invention to provide a computer-readable recording medium having recorded a worm determination program, a worm determination method, and a worm determination apparatus capable of reliably determining worm-infected communications.

To accomplish the above object, according to the present invention, there is provided a computer-readable recording medium having recorded a worm determination program for monitoring a communication associated with a predetermined network segment connected to a network and determining whether the communication is a communication performed by a worm. The worm determination program stored on this recording medium causes a computer to function as the following elements: a communication-information-acquisition unit for acquiring information about a packet type, classified according to a transmission-source address; and a worm determination unit for determining whether the communication is a communication performed by a worm based on the information about the packet type, classified according to the transmission-source address, acquired by the communication-information-acquisition unit and a determination criterion used for determining whether the communication is a communication performed by a worm.

To accomplish the above object, according to the present invention, there is provided a worm determination method for monitoring a communication associated with a predetermined network segment connected to a network and determining whether the communication is a communication performed by a worm. This worm determination method includes the following steps: causing a communication-information-acquisition unit to acquire information about a packet type, classified according to a transmission-source address; and causing a worm determination unit to determine whether the communication is a communication performed by a worm based on the information about the packet type, classified according to the transmission-source address, acquired by the communication-information-acquisition unit and a determination criterion used for determining whether the communication is a communication performed by a worm.

To accomplish the above object, according to the present invention, there is provided a worm determination apparatus for monitoring a communication associated with a predetermined network segment connected to a network and determining whether the communication is a communication performed by a worm. This worm determination apparatus includes the following elements: a communication-information-acquisition unit for acquiring information about a packet type, classified according to a transmission-source address; and a worm determination unit for determining whether the communication is a communication performed by a worm based on the information about the packet type, classified according to the transmission-source address, acquired by the communication-information-acquisition unit and a determination criterion used for determining whether the communication is a communication performed by a worm.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram roughly depicting a worm determination apparatus.

FIG. 2 is a diagram depicting an exemplary hardware structure of a worm determination apparatus.

FIG. 3 is a functional block diagram depicting a functional structure of a worm determination apparatus.

FIG. 4 is a diagram depicting one example of the structure of a packet used for communication.

FIG. 5 shows the structure of an Ether header.

FIG. 6 shows the structure of an IP header.

FIG. 7 shows the structure of a TCP header.

FIG. 8 is a diagram depicting another example of the structure of a packet used for communication.

FIG. 9 shows the structure of an ICMP header.

FIG. 10 shows setting data.

FIG. 11 is a diagram depicting an exemplary data structure of communication log data.

FIG. 12 is a diagram depicting an exemplary data structure of blocking data.

FIG. 13 is a flowchart illustrating a procedure of worm determination processing.

FIG. 14 is a flowchart illustrating a procedure for the process of communication blocking.

### DESCRIPTION OF THE PREFERRED EMBODIMENTS

Embodiments of the present invention will now be described in detail with reference to the drawings.

First, an outline of the invention applied to embodiments will be described, followed by specific descriptions of the embodiments.

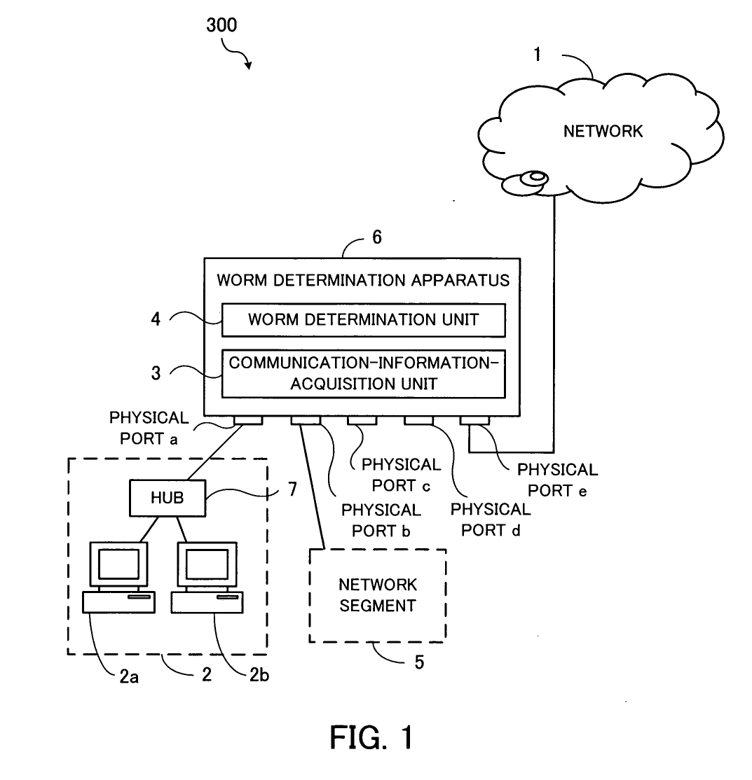

FIG. 1 is a diagram roughly depicting a worm determination apparatus.

A worm determination system 300 includes two network segments 2 and 5, each including, for example, at least one server apparatus or client apparatus, and a worm determination apparatus 6 via which the network segments 2 and 5 are connected to a network 1. The network 1 indicates a concept including the Internet, an intranet, and a network of an internet services provider (ISP).

The worm determination apparatus 6 includes at least one physical port (five physical ports “a” through “e” shown in FIG. 1), which is a network connection port; a communication-information-acquisition unit 3; and a worm determination unit 4.

The network segment 2 includes terminals 2a and 2b and a hub 7 to which the terminals 2a and 2b are connected.

The hub 7 is connected to the worm determination apparatus 6. In this manner, a plurality of terminals is connected to the physical ports “a” through “e” via a concentrator such as the hub 7. For communication from the terminals 2a and 2b, the communication-information-acquisition unit 3 provided in the worm determination apparatus 6 monitors packets input to the physical ports “a” through “e”. For example, in the case of a communication from the terminal 2a to a destination other than the physical port “a” via the physical port “a” (outbound communication from the perspective of the terminal 2a), the communication-information-acquisition unit 3 monitors packets input to the entrance of the physical port “a” and the worm determination unit 4 determines whether the communication by means of the communication packets is a communication performed by a worm. It should be noted, however, that communications from the terminal 2a to the terminal 2b performed only via the hub 7 (without passing through the physical port “a”) are not monitored at the physical port “a”.

More specifically, the communication-information-acquisition unit 3 acquires information per unit time of communication packets, such as the transmission-source IP addresses, destination IP addresses, destination ports, communication protocols, and control bits, and the worm determination unit 4 determines based on the acquired information whether there is a worm attack from the network segment to a computer in another network segment.

Here, a change in information about the destination IP address of each communication packet per unit time of communication packets, as a result of being infected with a worm, is noticeable regardless of the type of the computer, that is, whether the computer is a server apparatus or a client apparatus. In this worm determination apparatus 6, therefore, the worm can be detected easily and efficiently whether the apparatus for which the worm is detected is a server apparatus or a client apparatus.

Specific descriptions of the present invention follow.

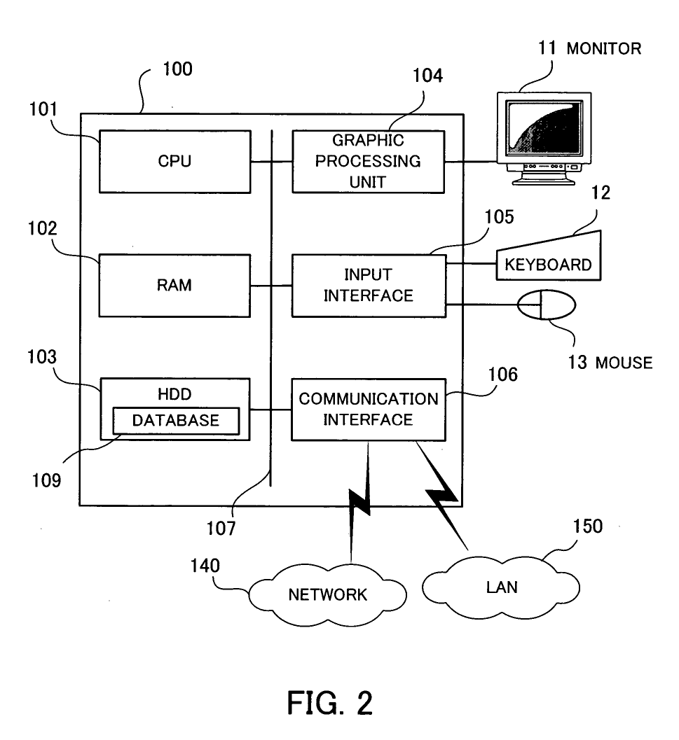

FIG. 2 is a diagram depicting an exemplary hardware structure of a worm determination apparatus.

A worm determination apparatus 100 is under control of a central processing unit (CPU) 101. A random access memory (RAM) 102, a hard disk drive (HDD) 103, a graphic processing unit 104, an input interface 105, and a communication interface 106 are connected to the CPU 101 via a bus 107.

At least part of an operating system (OS) program and application programs to be executed by the CPU 101 is temporarily stored in the RAM 102. Various data necessary for processing by the CPU 101 is also stored in the RAM 102. The OS and application programs are stored in the HDD 103. In addition, a database 109 is generated in the HDD 103.

A monitor 11 is connected to the graphic processing unit 104. The graphic processing unit 104 displays images on the screen of the monitor 11 according to a command from the CPU 101. A keyboard 12 and a mouse 13 are connected to the input interface 105. The input interface 105 transmits signals sent from the keyboard 12 and the mouse 13, to the CPU 101 via the bus 107.

The communication interface 106 is connected to a network 140 and a local area network (LAN) 150. The communication interface 106 performs transmission and reception of data to and from other computers via the network 140 and LAN 150. The LAN 150 is a network such as an intranet.

The processing functions of this embodiment can be realized with the above-described hardware configuration. In a system with the above-described hardware configuration, the worm determination apparatus 100 is provided with the following functions to determine a worm.

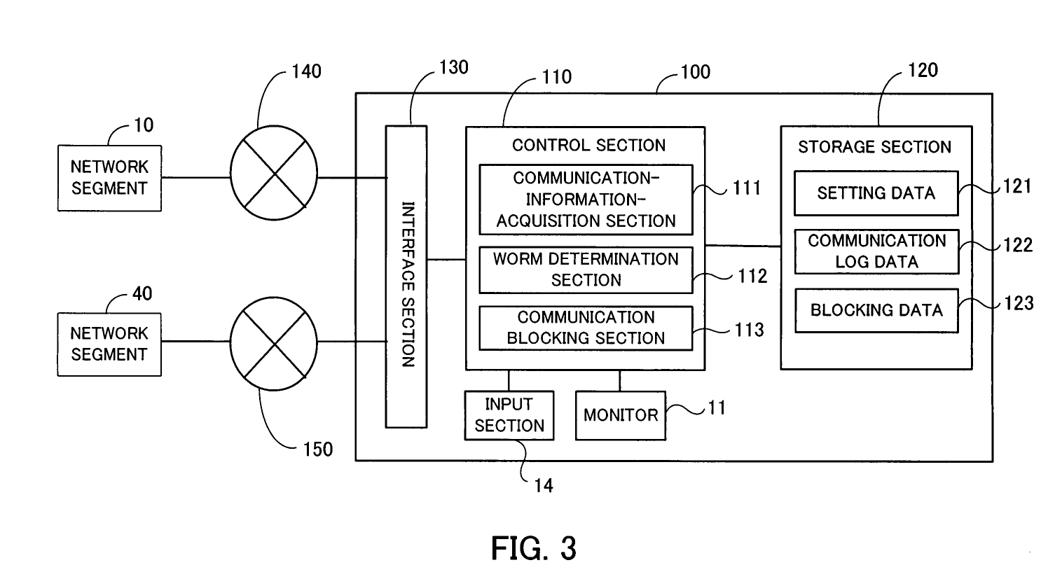

FIG. 3 is a functional block diagram depicting a functional structure of the worm determination apparatus 100.

As shown in FIG. 3, this worm determination apparatus 100 is connected to the network 140 excluding a network segment 10 (corresponding to the network segment 2 in FIG. 1), namely, the above-described network segment 5, and to the higher-level network 1 (a network segment 40 in FIG. 3).

Based on setting data associated with information acquisition, the worm determination apparatus 100 acquires information about communication addresses, communication ports, and communication protocols of communication packets to determine whether a communication is a communication performed by a worm, based on the acquired information and information associated with a determination criterion for defining whether a communication is a communication carried out by a worm.

A packet used for communication will now be described.

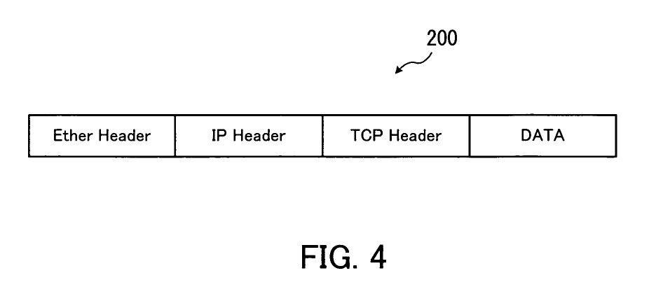

FIG. 4 is a diagram depicting one example of the structure of a packet used for communication.

A packet 200 includes an Ether header, an IP header, a Transmission Control Protocol (TCP) header (TCP header), and data in that order starting from the top thereof.

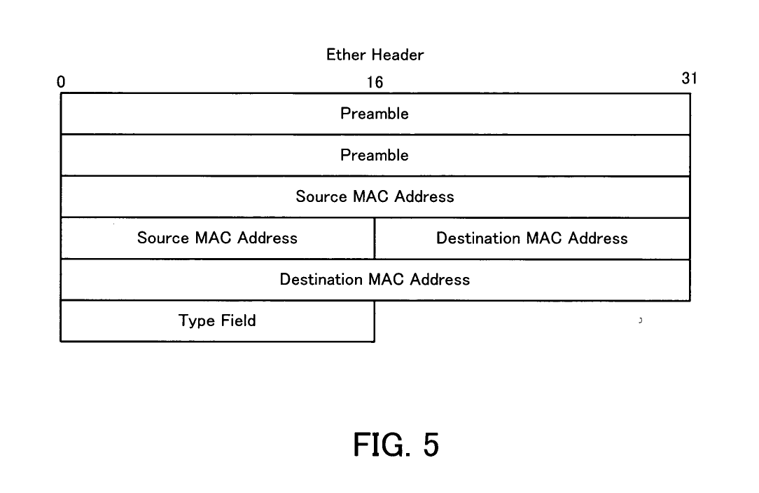

FIG. 5 shows the structure of the Ether header.

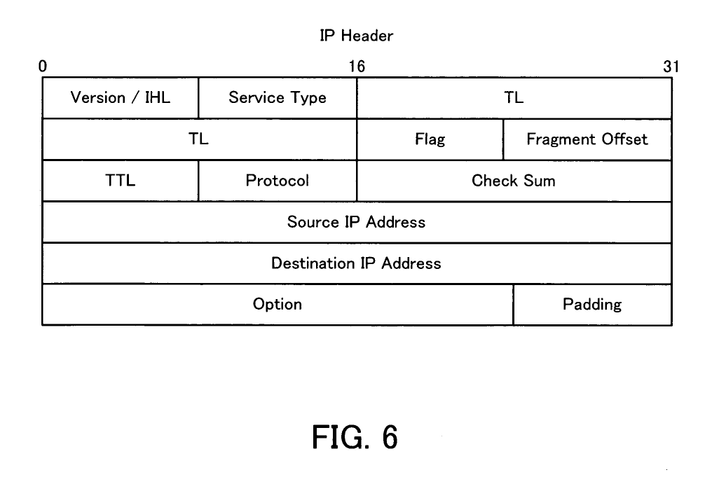

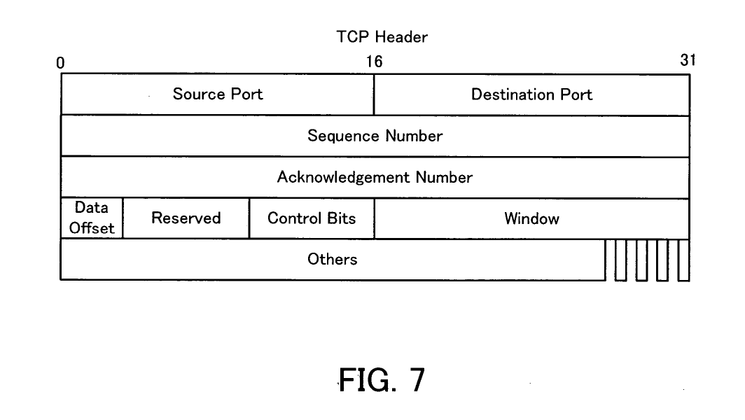

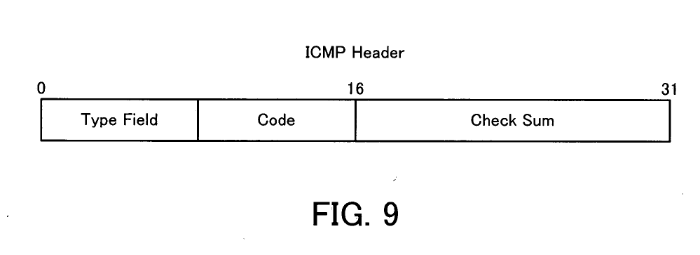

In FIG. 5, each line is represented in 32 bits for the sake of simplicity (also in FIG. 6, FIG. 7, and FIG. 9).

The Ether header includes a preamble, a transmission-source MAC address (source Mac address), a destination MAC address, and a type field in that order starting from the top thereof.

FIG. 6 shows the structure of the IP header.

The IP header includes a version/header length (version/IHL), a service type, a packet length (TL), a flag, a fragment offset, a time to live (TTL), a protocol, a header checksum (check sum), a transmission-source IP address (source IP address), a destination IP address, an option, and padding in that order starting from the top thereof.

FIG. 7 is shows the structure of the TCP header.

The TCP header includes a transmission-source port (source port), a destination port, a sequence number, an acknowledgment number, a data offset, reservation (reserved), control bits, a window, and others in that order starting from the top thereof.

Of these, the control bits (code bits) include an urgent flag (URG), an acknowledgement flag (ACK), a push flag (PSH), a reset flag (RST), a synchronize flag (SYN), and a fin flag (FIN), each composed of one bit.

A UDP header includes a transmission-source port (source port), a destination port, a datagram length (length), and a checksum (check sum) (not shown in the figure) in that order starting from the top thereof. Information regarding the destination port can be acquired as from the TCP header.

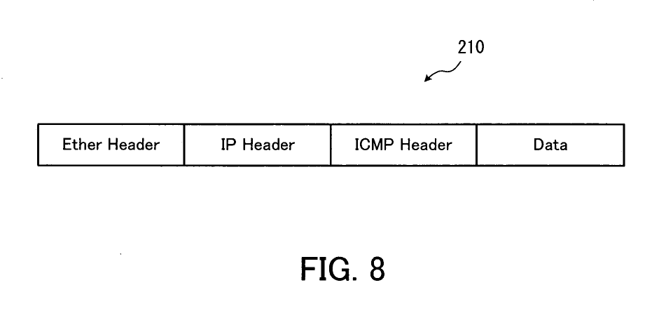

FIG. 8 is a diagram depicting another example of the structure of a packet used for communication.

A packet 210 includes an Ether header, an IP header, an Internet Control Message Protocol (ICMP) header, and data in that order starting from the top thereof.

Since the structures of the Ether header and the IP header are the same as those in the packet 200, a description thereof will thus be omitted.

FIG. 9 shows the structure of the ICMP header.

The ICMP header includes a type field, a code, and a checksum (check sum).

Referring back to FIG. 3, this worm determination apparatus 100 includes a control section 110 provided with a communication-information-acquisition section 111, a worm determination section 112, and a communication blocking section 113; an input section 14; the monitor 11; a storage section 120; and an interface section 130.

The input section 14 is realized by an input device such as the keyboard 12 and the mouse 13. The storage section 120 is formed of storage devices such as the RAM 102 and the HDD 103. Setting data 121, communication log data 122, and blocking data 123 are stored in this storage section 120.

The communication-information-acquisition section 111 acquires information about communication addresses, communication ports, and communication protocols of communication packets based on the setting data 121 stored in the storage section 120. More specifically, this communication-information-acquisition section 111 acquires packet header information, such as destination IP addresses, transmission-source addresses, destination ports, and protocols, from the headers of the packet 200 and the packet 210 and performs the process of storing the destination IP addresses in the communication log data 122, classified according to the transmission-source addresses and the destination port numbers. In this case, the communication log data 122 may be data in the RAM 102.

As the transmission-source address, either the transmission-source MAC address provided in the Ether header or the transmission-source IP address provided in the IP header may be used. The current description assumes that the transmission-source IP address is used as the transmission-source address.

Based on the information acquired by the communication-information-acquisition section 111 and the setting data 121 stored in the storage section 120, the worm determination section 112 counts the number of destination IP address types, classified according to the transmission-source IP addresses, destination port numbers, and protocols, to determine whether a predetermined transmission-source IP address, a destination port, and a protocol are associated with a communication performed by a worm.

When the worm determination section 112 determines that the communication in question is a packet communication performed by a worm, the communication blocking section 113 blocks the packet communication performed by the worm. The communication blocking section 113 performs three types of worm blocking based on the transmission-source IP addresses, the protocols, and the destination port numbers obtained as a result of the determination processing. For a first type of blocking, an infected port used by the transmission-source IP address regarded as the original source of infection is blocked. By doing so, while it is possible to block only communications that use the infected port from the worm-infected terminal (hereinafter, referred to as the “infected terminal”), communications that use other ports from the infected terminal are allowed. For a second type of blocking, only an infected port is blocked in communications from all terminals via physical ports. By doing so, packet communications performed by a worm can be blocked in advance at the physical port even if other terminals are infected. For the last third type of blocking, all communication packets sent from the infected terminal are blocked. By doing so, it is possible to prevent in advance the worm from using a plurality of ports for communication.

The setting data 121 includes various items of setting information, such as setting information associated with the acquisition of information about communication addresses, communication ports, and communication protocols of communication packets and information associated with a determination criterion for defining whether a communication being monitored is a communication carried out by a worm.

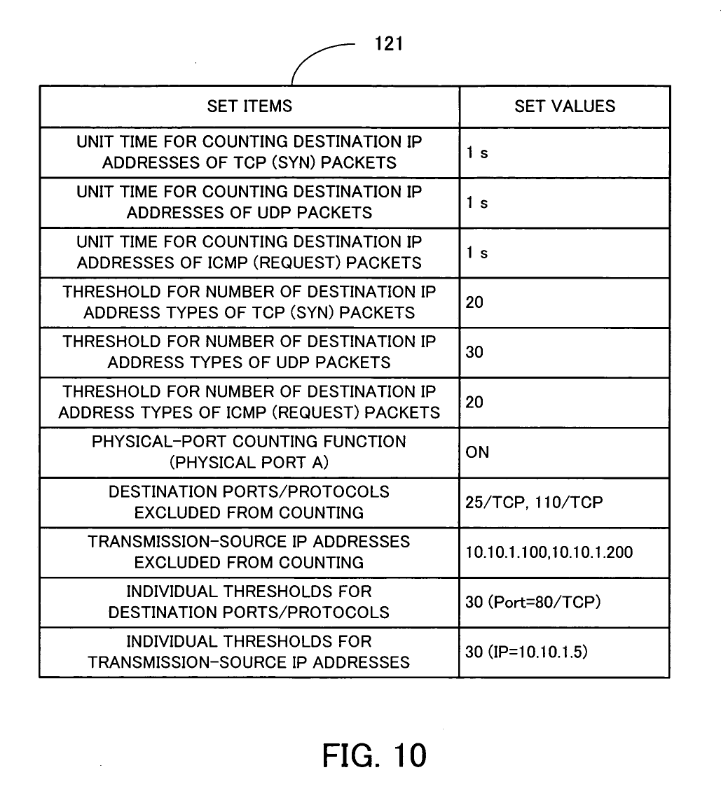

FIG. 10 shows the setting data.

The setting data 121 includes columns “set items” and “set values,” where the pieces of information in the columns arranged horizontally are associated with each other. The set items are items that are set for the setting data 121, and the set values are set information referred to when the settings of the setting data 121 are accepted.

More specifically, the above-described set items include a “unit time for counting destination IP addresses of TCP (SYN) packets;” a “unit time for counting destination IP addresses of User Datagram Protocol (UDP) packets;” a “unit time for counting destination IP addresses of ICMP (request) packets;” a “threshold for the number of destination IP address types of TCP (SYN) packets;” a “threshold for the number of destination IP address types of UDP packets;” a “threshold for the number of destination IP address types of ICMP (request) packets;” a “physical-port counting function;” “destination ports/protocols excluded from counting;” “transmission-source IP addresses excluded from counting;” “individual thresholds for destination ports/protocols;” and “individual thresholds for transmission-source IP addresses.”

The “unit time for counting destination IP addresses of TCP (SYN) packets” is a unit time for which the number of destination IP address types of packets in which the SYNs of the TCP headers are set (SYN packets, which are TCP-based packets) is counted.

The “unit time for counting destination IP addresses of UDP packets” is a unit time for which the number of destination IP address types of UDP packets, which are UDP-based packets, is counted.

The “unit time for counting destination IP addresses of ICMP (request) packets” is a unit time for which the number of destination IP address types of ICMP (request) packets for transmitting an Echo Req (echo request) of a communication-partner computer is counted.

For example, when these unit times for counting is one second, the number of destination IP address types of the above-described packets are counted for one second, classified according to the transmission-source IP addresses and the destination ports.

The “threshold for the number of destination IP address types of TCP (SYN) packets,” the “threshold for the number of destination IP address types of UDP packets,” and the “threshold for the number of destination IP address types of ICMP (request) packets” are information about thresholds for the numbers of destination IP address types that are used by the worm determination section 112 to determine whether there is a communication being performed by a worm. The number of destination IP address types is the number of different destination IP addresses counted in the unit time for counting the number of destination IP address types, classified according to the transmission-source IP addresses and the destination ports. For example, the “threshold for the number of destination IP address types of TCP (SYN) packets” is set to 20, the “threshold for the number of destination IP address types of UDP packets” is set to 30, and the “threshold for the number of destination IP address types of ICMP (request) packets” is set to 20 in FIG. 10.

The “physical-port counting function” is set for each physical port of the worm determination apparatus 100. As one example, a set value for a predetermined physical port A is shown in FIG. 10. For each physical port, counting is performed when this physical-port counting function is set ON and counting is not performed when it is set OFF. By doing so, it can be determined whether counting is performed for individual physical ports.

One or more destination ports/protocols to be excluded from counting can be set in the “destination ports/protocols excluded from counting.” As examples, a destination port 25 in the TCP protocol and a destination port 110 in the TCP protocol are set in FIG. 10.

One or more transmission-source IP addresses to be excluded from counting can be set in the “transmission-source IP addresses excluded from counting.” As examples, IP addresses “10.10.1.100” and “10.10.1.200” are set in FIG. 10.

At this time, the physical port of which the column “set values” of the “physical-port counting function” is set ON, the destination ports and protocols set in the column “set values” of the “destination ports/protocols excluded from counting,” or the transmission-source IP addresses set in the column “set values” of the “transmission-source IP addresses excluded from counting” is not added to a new destination table of the communication log data 122 or, even if added to the new destination table, is excluded from worm determination. By doing so, for example, a management terminal which performs communication with a plurality of destination addresses for a short period of time can be excluded in advance, and therefore, erroneous detection can be prevented easily and reliably.

One or more individual thresholds can be set in the “individual thresholds for destination ports/protocols,” as required, for each packet type, that is, for each destination port/protocol. A threshold for a destination port in a protocol set as set values of this cell is effective regardless of the set value in the “threshold for the number of destination IP address types of TCP (SYN) packets.” In FIG. 10, as one example, the threshold for a destination port 80 in the TCP protocol is set to 30. Therefore, a threshold of 30 for the destination port 80 is effective, regardless of the set value 20 in the “threshold for the number of destination IP address types of TCP (SYN) packets.”

One or more individual thresholds can be set in the “individual thresholds for transmission-source IP addresses,” as required, for each transmission-source IP address. In FIG. 10, as one example, the threshold for an IP address “10.10.1.5” is set to 30. Therefore, a threshold of 30 for the number of packet types for the IP address “10.10.1.5” is effective, regardless of the set values in the “threshold for the number of destination IP address types of TCP (SYN) packets,” the “threshold for the number of destination IP address types of UDP packets,” and the “threshold for the number of destination IP address types of ICMP (request) packets.”

Referring back to FIG. 3, the communication log data 122 represents a table for counting the number of destination IP address types associated with packet types (transmission-source IP address, destination port, and protocol) for each transmission-source IP address.

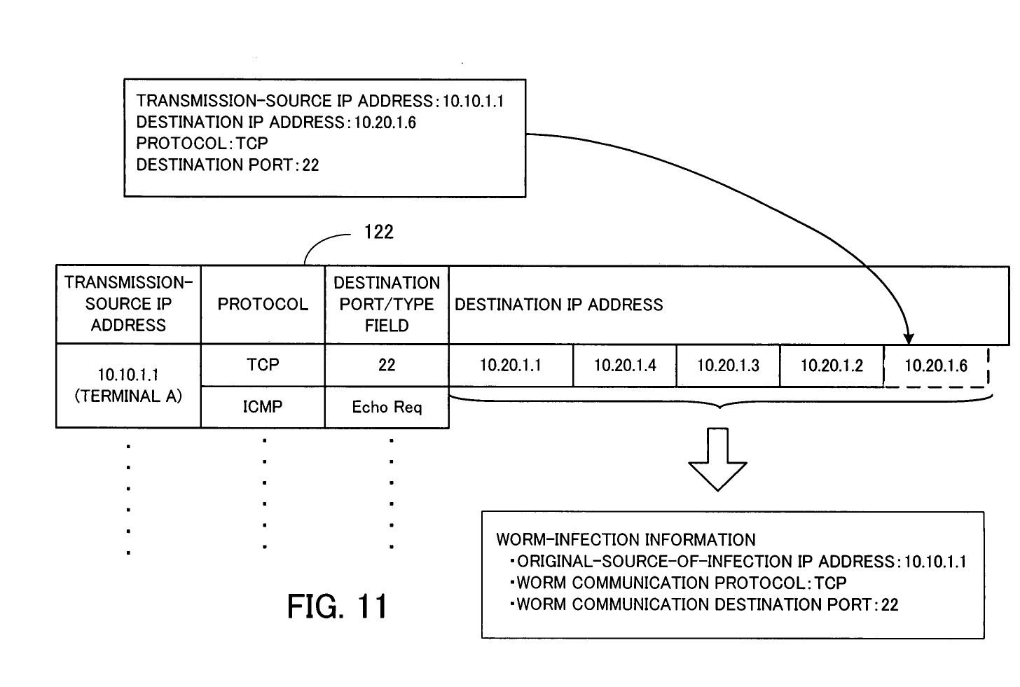

FIG. 11 is a diagram depicting an exemplary data structure of the communication log data 122.

The communication log data 122 includes columns “transmission-source IP address,” “protocol,” “destination port/type field,” and “destination IP address,” where the pieces of information arranged horizontally are associated with each other.

The communication log data 122 shows various pieces of information acquired for the unit time, and worm detection is assumed if the number of destination IP address types per unit time is equal to or larger than a predetermined threshold. For example, in a case where the transmission-source IP address of a predetermined terminal in the network segment 10 is “10.10.1.1;” the destination port is 22; the destination IP addresses per unit time include four types “10.20.1.1,” “10.20.1.2,” “10.20.1.3,” and “10.20.1.4” for the TCP protocol; and the subsequent new information acquired by the communication-information-acquisition section 111 includes a transmission-source IP address “10.10.1.1,” a destination IP address “10.20.1.6,” a destination port “22”, and a protocol “TCP”, the destination IP address for the transmission-source IP address, the destination port, and the protocol in the newly acquired information is new in the unit time. Therefore, the number of destination IP address types for the transmission-source IP address “10.10.1.1,” the destination port 22, and the protocol TCP is 5. When the threshold for the number of destination IP address types of TCP (SYN) packets described in the setting data 121 has been set to “5,” the monitored number of destination IP address types is recognized as being equal to or larger than the threshold, and therefore the terminal with the transmission-source IP address “10.10.1.1” is detected as a worm-infected terminal. At this time, the original-source-of-infection IP address “10.10.1.1,” the worm communication protocol “TCP”, and the worm communication destination port “22” are output and displayed on the monitor 11 as worm-infection information.

Also, if the transmission-source IP address is “10.10.1.1;” the type field is Echo Req; and the number of types of predetermined destination IP addresses per unit time with the TCP protocol is equal to or larger than the “threshold for the number of destination IP address types of ICMP (request) packets,” then the terminal with the transmission-source IP address “10.10.1.1” is detected as a worm-infected terminal. At this time, the original-source-of-infection IP address “10.10.1.1,” the worm communication protocol “ICMP”, and the worm communication type field “Echo Req” are output and displayed on the monitor 11 as worm-infection information.

Referring back again to FIG. 3, the blocking data 123 stores information regarding the originally blocked IP address (transmission-source IP address), the destination port, and the communication protocol for which blocking has been performed. New worm-infection information is added to the blocking data 123 each time blocking is performed to update the blocking data 123. Furthermore, when blocking is released, the corresponding worm-infection information is deleted to update the blocking data 123.

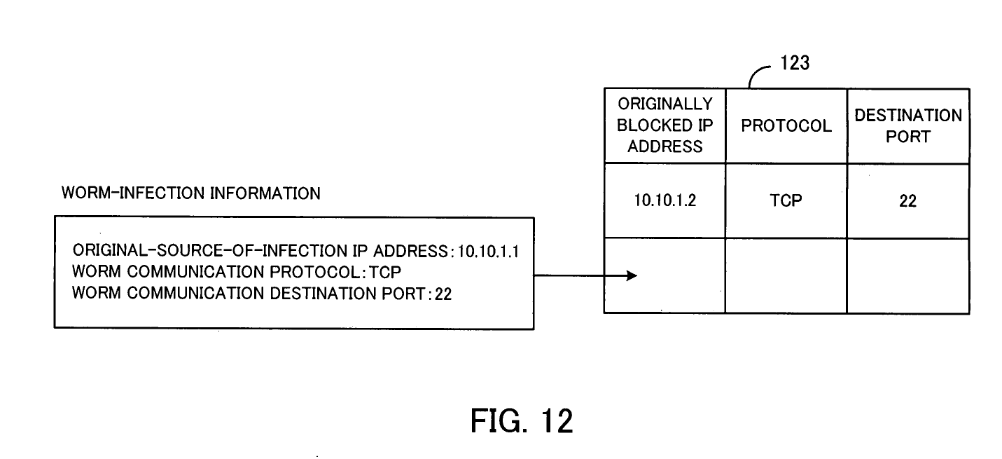

FIG. 12 is a diagram depicting an exemplary data structure of the blocking data 123.

The blocking data 123 includes columns “originally blocked IP address,” “protocol,” and “destination port,” where the pieces of information arranged horizontally are associated with each other.

When new worm-infection information is sent from the worm determination section 112, the original-source-of-infection IP address is set anew in the column “originally blocked IP address,” the worm communication protocol is set anew in the column “protocol,” and the destination port is set anew in “destination port.”

In the example of FIG. 12, an IP address “10.10.1.1” is set anew below the originally blocked IP address “10.10.1.2,” and a TCP is set anew below the protocol TCP, and a destination port 22 is set anew below the destination port 22.

If worm-infection information sent from the worm determination section 112 completely matches an originally blocked IP address, the corresponding protocol, and the corresponding destination port already set in the blocking data 123, then the blocking data 123 is not updated.

Referring back to FIG. 3, the interface section 130 includes a plurality of physical ports (not shown in the figure) to serve as network interfaces for performing transmission and reception of communication data between the network segment 10 and the network segment 40 via the network 140 and the LAN 150.

Worm determination processing performed by the worm determination apparatus 100 will now be described.

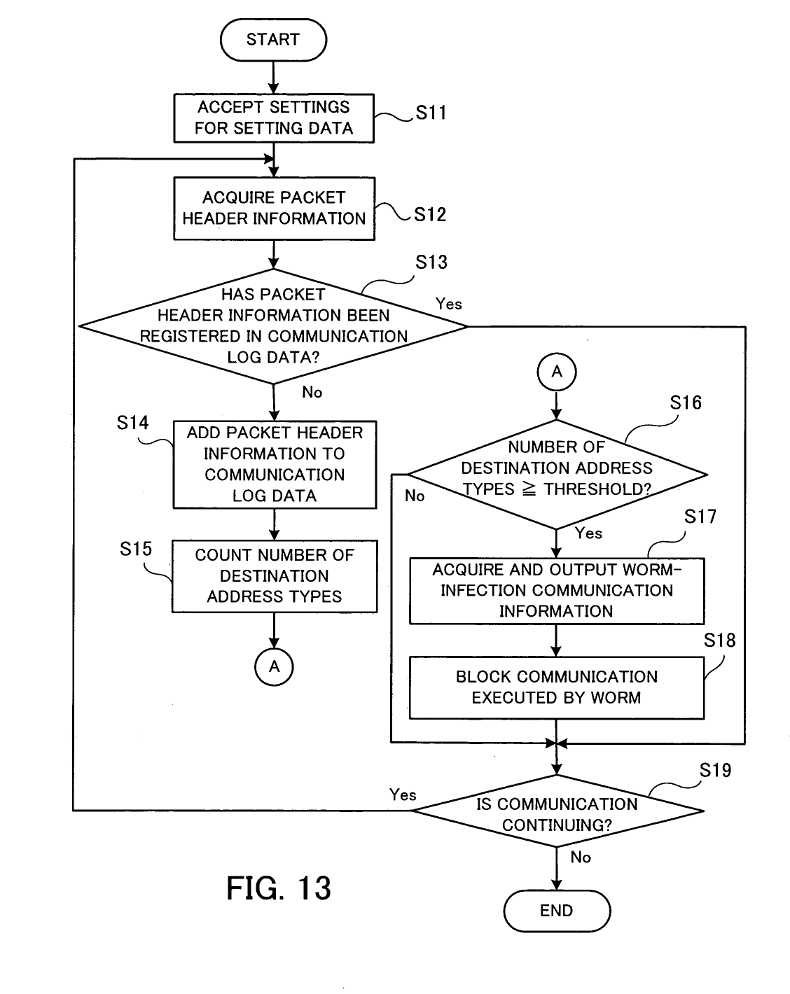

FIG. 13 is a flowchart illustrating a procedure of worm determination processing.

First, the communication-information-acquisition section 111 accepts settings for the setting data 121 (step S11). Subsequently, the communication-information-acquisition section 111 monitors network communications between a computer in the network segment 10 and a computer in the network segment 40 and acquires packet information in a fixed-length part from the top of a packet, in short, packet header information including the destination IP address, transmission-source IP address, destination port, protocol, and the like (step S12). Then, the communication-information-acquisition section 111 determines whether the acquired packet header information has been registered in the communication log data 122 (step S13).

When the acquired packet header information has been registered in the communication log data 122 (Yes in step S13), the flow proceeds to step S19. On the other hand, when the acquired packet header information has not been registered in the communication log data 122 (No in step S13), the packet header information is added to the communication log data 122 (step S14). Subsequently, the worm determination section 112 counts the number of destination IP address types, classified according to transmission-source IP addresses, destination ports, and protocols, within the unit time for counting, set in the setting data 121 (step S15) and determines whether the number of destination IP address types is equal to or larger than the threshold (step S16). When the number of destination IP address types is equal to or larger than the threshold (Yes in step S16), the worm determination section 112 determines that the packet communication is performed by a worm, acquires worm-infection information, such as the transmission-source IP address, the destination port, and the protocol, and outputs the worm-infection information (step S17).

Subsequently, the communication blocking section 113 performs the process of communication blocking, in short, the process of blocking the packet communication executed from the transmission-source address determined as performed by the worm (step S18).

On the other hand, when the number of destination IP address types is below the threshold (No in step S16), it is not determined that the packet communication is performed by a worm and the flow proceeds to step S19.

Subsequently, the worm determination apparatus 100 determines whether the communication is continuing (step S19).

When the communication is continuing (Yes in step S19), the flow proceeds to step S12 to repeat the subsequent processes.

When the communication is not continuing (No in step S19), the worm determination processing is ended.

The process of communication blocking executed by the worm determination apparatus 100 will now be described.

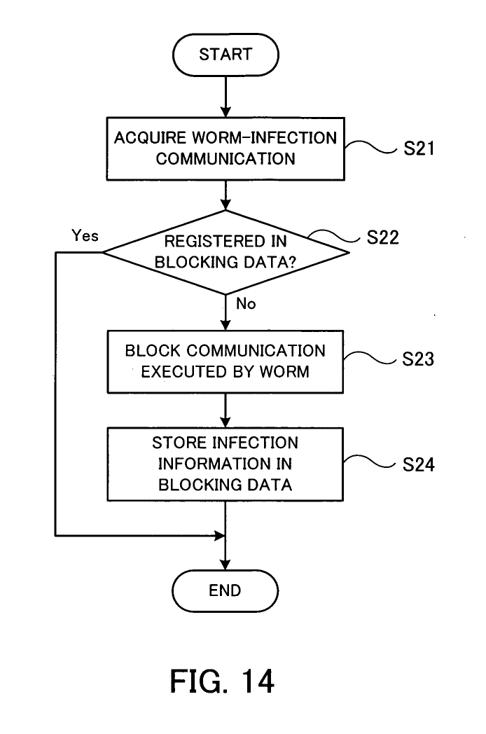

FIG. 14 is a flowchart illustrating a procedure for the process of communication blocking.

First, the communication blocking section 113 acquires worm-infection information (the original-source-of-infection IP address, the worm communication protocol, and the worm communication port) output from the worm determination section 112 (step S21).

Then, it is determined whether the acquired worm-infection information has been registered in the blocking data 123 (step S22).

When the acquired worm-infection information has been registered in the blocking data 123 (Yes in step S22), the process of communication blocking is ended.

On the other hand, when the acquired worm-infection information has not been registered in the blocking data 123 (No in step S22), the communication executed by the worm is blocked (step S23).

Then, the infection information is stored in the blocking data 123 (step S24).

Subsequently, the process of communication blocking is ended.

As described above, according to the worm determination apparatus 100 of this embodiment, information about each combination of a protocol and a destination port or each combination of a protocol and a type field is acquired for each transmission-source address, such as a transmission-source IP address or a transmission-source MAC address, and the number of types of destination IP addresses corresponding to each combination is counted. Therefore, the transmission-source address where a worm is being sent can be detected reliably. In addition, communication packets associated with the detected worm can be easily and reliably blocked by the communication blocking section 113.

As a result, only worm-infected communications can be blocked reliably without blocking normal communications executed by a non-infected terminal that uses the same service port as the worm.

Furthermore, since worm determination can be performed by acquiring information in fixed-length parts from the tops of the packet 200 and packet 210, the time for reading the packet 200 and the packet 210 during the worm determination processing is reduced and high-speed processing can be achieved.

The above-described processing functions can be realized by a computer. In that case, a worm determination program describing the processing of the functions to be owned by the worm determination apparatus 100 is provided. By executing the program on a computer, the above-described processing functions are realized on the computer. The program describing the processing can be recorded in a computer-readable recording medium. Computer-readable recording media include magnetic recording apparatuses, optical disks, magneto-optical recording media, semiconductor memories, and so forth. The magnetic recording apparatuses include hard disk apparatuses (HDDs), flexible disks (FDs), magnetic tapes, and so forth. The optical disks include digital versatile discs (DVDs), digital versatile disc random access memories (DVD-RAMs), compact disc read only memories (CD-ROMs), CD-recordables (CD-Rs)/CD-rewritables (CD-RWs), and so forth. The magneto-optical recording media include magneto-optical disks (MOs) and so forth.

When the program is to be distributed, portable recording media, such as DVDs and CD-ROMs, in which the program is recorded are sold. Furthermore, the program can be stored in a storage device of a server computer so that the program can be transferred from the server computer to another computer via a network.

When the program is to be executed on a computer, the computer stores in a storage device thereof the program recorded, for example, in a portable recording medium or the program transferred from the server computer. Then, the computer reads out the program from the storage device thereof and executes processing according to the program. The computer can read out the program directly from the portable recording medium to execute processing according to the program. Alternatively, each time the program is transferred from the server computer, the computer can execute processing according to the received program.

According to the present invention, information about packet types is acquired for each transmission-source address as a counting unit, and therefore, more detailed information about worm infection can be acquired to reliably determine worm-infected communications.

Especially when a communication from a worm-infected original source of infection is to be blocked, the communication can be blocked for individual packet types. This allows only communications performed by a worm to be blocked reliably.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable recording medium having recorded a worm determination program for monitoring a communication associated with a predetermined network segment connected to a network and determining whether the communication is a communication performed by a worm, the program causing a computer to function as:
communication-information-acquisition means for acquiring information about the type of a packet, classified according to a transmission-source address; and
worm determination means for determining whether the communication is a communication performed by a worm based on the information about the type of a packet, classified according to the transmission-source address, acquired by the communication-information-acquisition means and a determination criterion used for determining whether the communication is a communication performed by a worm.

2. The computer-readable recording medium having recorded a worm determination program according to claim 1, wherein the communication-information-acquisition means acquires information in a fixed-length part of the packet.

3. The computer-readable recording medium having recorded a worm determination program according to claim 1, wherein the information about the type of a packet comprises information about a protocol and a destination port.

4. The computer-readable recording medium having recorded a worm determination program according to claim 1, wherein the information about the type of a packet comprises information about a protocol and a type field.

5. The computer-readable recording medium having recorded a worm determination program according to claim 1, wherein the worm determination means determines that the communication is a communication performed by a worm when the number of types of destination IP addresses identified based on the type of a packet per unit time is equal to or larger than a predetermine value.

6. The computer-readable recording medium having recorded a worm determination program according to claim 5, wherein the predetermined value can be set for each type of a packet.

7. The computer-readable recording medium having recorded a worm determination program according to claim 5, wherein the predetermined value can be set for each transmission-source address.

8. The computer-readable recording medium having recorded a worm determination program according to claim 5, wherein the information about the type of a packet comprises information about a protocol and a destination port, and
it can be set for each protocol and for each destination port whether the determination is performed by the worm determination means.

9. The computer-readable recording medium having recorded a worm determination program according to claim 5, wherein it can be set for each transmission-source address whether the determination is performed by the worm determination means.

10. The computer-readable recording medium having recorded a worm determination program according to claim 1, further comprising:
communication blocking means for blocking a communication when the worm determination means determines that the communication is a communication performed by a worm.

11. The computer-readable recording medium having recorded a worm determination program according to claim 10, wherein the communication blocking means is capable of blocking the worm for each type of a packet.

12. The computer-readable recording medium having recorded a worm determination program according to claim 1, wherein the transmission-source address is a transmission-source IP address or a transmission-source MAC address.

13. A worm determination method for monitoring a communication associated with a predetermined network segment connected to a network and determining whether the communication is a communication performed by a worm, comprising the steps of:
causing communication-information-acquisition means to acquire information about the type of a packet, classified according to a transmission-source address; and
causing worm determination means to determine whether the communication is a communication performed by a worm based on the information about the type of a packet, classified according to the transmission-source address, acquired by the communication-information-acquisition means and a determination criterion used for determining whether the communication is a communication performed by a worm.

14. A worm determination apparatus for monitoring a communication associated with a predetermined network segment connected to a network and determining whether the communication is a communication performed by a worm, comprising:
communication-information-acquisition means for acquiring information about the type of a packet, classified according to a transmission-source address; and
worm determination means for determining whether the communication is a communication performed by a worm based on the information about the type of a packet, classified according to the transmission-source address, acquired by the communication-information-acquisition means and a determination criterion used for determining whether the communication is a communication performed by a worm.

15. The worm determination apparatus according to claim 14, further comprising:
a plurality of physical ports connected to the network, wherein it can be set for each physical port whether worm determination is performed by the worm determination means.
